(19) United States
(12) Patent Application Publication
(10) Pub. No.: US 2026/0179143 A1
(43) Pub. Date: Jun. 25, 2026

(54) Meta Registry for Blockchain Transactions

(71) Applicant: S&P Global Inc., New York, NY (US)

(72) Inventors: Stanley Guzik, Ridgewood, NJ (US); Nikodem Sebastian Lacki, London (GB); Nikhil Bhanushali, Cedar Grove, NJ (US); Chris Ka Ho Li, London (GB); Muhammed Eren, London (GB); David Costa Faidella, London (GB); Calvin Beloy, Livingston, NJ (US)

(21) Appl. No.: 18/987,234

(22) Filed: Dec. 19, 2024

(51) Int. Cl. G06Q 40/04; G06Q 20/38

(52) U.S. Cl. CPC G06Q 40/04; G06Q 20/389

(57) ABSTRACT

A blockchain transaction system is provided. The system comprises a number of registries, a blockchain network, and a meta registry. The meta registry comprises a frontend interface for the registries, a server side backend that provides a set of application programming interfaces (APIs) to integrate the registries with the meta registry, and a middleware system that connects the server side backend to a number of clients in the blockchain network. The meta registry instructs the blockchain network to issue and mint tokens in response to API calls from the registries. The meta registry also instructs the blockchain network to sell, transfer, or retire tokens in response to API calls from the registries.

### BACKGROUND INFORMATION

### 1. Field

The present disclosure relates generally to blockchain transactions, and more specifically to providing a meta registry between a market registry and a blockchain network.

### 2. Background

The voluntary carbon market is a platform where organizations and individuals can buy and sell carbon credits voluntarily to offset their greenhouse gas emissions voluntarily, outside of regulatory requirements. Participants purchase credits generated by projects that reduce or capture greenhouse gas emissions. These markets exist in parallel to compliance carbon markets, which are mandatory and regulated by governments or international bodies.

However, existing voluntary carbon market systems face challenges related to quality of credits, double counting, transparency, traceability, interoperability, efficiency, and the absence of standardized regulations.

### SUMMARY

An illustrative embodiment provides meta registry for blockchain transactions. The meta registry comprises a frontend interface for a number of registries, a server side backend that provides a set of application programming interfaces (APIs) to integrate the registries with the meta registry, and a middleware system that connects the server side backend to a number of clients in a blockchain network.

Another illustrative embodiment provides a blockchain transaction system. The system comprises a number of registries, a blockchain network, and a meta registry. The meta registry comprises a frontend interface for the registries, a server side backend that provides a set of application programming interfaces (APIs) to integrate the registries with the meta registry, and a middleware system that connects the server side backend to a number of clients in the blockchain network. The meta registry instructs the blockchain network to issue and mint tokens in response to API calls from the registries. The meta registry also instructs the blockchain network to sell, transfer, or retire tokens in response to API calls from the registries.

Another illustrative embodiment provides a carbon credit blockchain transaction system. The system comprises a number of registries for a voluntary carbon market, a blockchain network configured, and a meta registry. The meta registry comprises a server side backend that provides a set of application programming interfaces (APIs) to integrate the registries with the meta registry and a middleware system that connects the server side backend to a number of clients in the blockchain networks. The meta registry instructs the blockchain network to execute smart contracts for tokens corresponding to carbon credits on the voluntary carbon market in response to API calls from the registries, wherein the tokens are based on ERC-1155, ERC-1594, and ERC-5484 token standards. Events related to the smart contracts are logged in a decentralized indexing system.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of a voluntary carbon market trading system depicted in accordance with an illustrative embodiment;

FIG. 3 depicts a diagram illustrating the implementation of a meta registry in accordance with an illustrative embodiment;

FIG. 4 depicts a process of issuing a given vintage and quantity of carbon credit units in the voluntary carbon market in accordance with an illustrative embodiment;

FIG. 5 depicts a diagram illustrating a provenance mechanism in accordance with an illustrative embodiment;

FIG. 6 depicts a flowchart illustrating Carbon Credit Unit token transfer in a ZK-SNARK blockchain network in accordance with an illustrative embodiment;

FIG. 7 depicts a carbon credit token in accordance with an illustrative embodiment;

FIG. 8 is a block diagram of a data processing system in accordance with an illustrative embodiment.

### DETAILED DESCRIPTION

The illustrative embodiments recognize and take into account that existing voluntary carbon market systems face challenges related to quality of credits, double counting, transparency, traceability, interoperability, efficiency, and the absence of standardized regulations.

Double counting occurs when the same greenhouse gas (GHG) emission reduction or removal is counted more than once toward achieving mitigation targets or goals.

Double counting may occur in two scenarios. The first is double issuance wherein carbon credits are issued more than one registry for the same project. The second is double claiming wherein multiple parties claim the same emission reduction.

The illustrative embodiments recognize and take into account that uncertainty surrounds the quality of carbon credits in the voluntary carbon market. Buyers need assurance that these credits indeed lead to emissions reductions and removals. The absence of clear standards for carbon credits makes it challenging for companies to verify whether they are genuinely reducing emissions.

The illustrative embodiments recognize and take into account that critical infrastructure providers and institutional investors struggle to access the market effectively due to inadequate system flexibility and lack of connectivity.

The illustrative embodiments recognize and take into account that the voluntary carbon market lacks liquidity necessary for efficient trading due to its complexity and that each carbon credit has unique attributes tied to the underlying project (e.g., project type, region), resulting in heterogeneity that makes standardization difficult.

The illustrative embodiments also recognize and take into account that there is no unique identifying serial number to track each voluntary carbon credit and the lifecycle of each credit on a public ledger to ensure transparency and accountability. Different registries and platforms must communicate seamlessly to maintain traceability.

The illustrative embodiments provide a meta registry built on an Ethereum Virtual Machine (EVM)-compatible blockchain. The meta registry employs a token design that comprises several Ethereum Request for Comments (ERC) token standards including ERC-1155, ERC-1594, and ERC-5484. This combination of Ethereum token standards provides composability and interoperability with other decentralized finance (DeFi) protocols, which can enable new financial services and products for carbon credit holders and traders.

The illustrative embodiments also provide liquidity of tokens across multiple blockchain and distributed ledger technology (DLT) networks, thereby making cross chain atomic swap of tokens possible. By providing composability to other DeFi protocols across different networks, participants can utilize various liquidity pools, lending protocols, and decentralized exchanges to incorporate carbon credit tokens as part of their portfolios and trading strategies.

As carbon credit tokens become a regulated financial instrument in the future, incorporating the security token standard of the illustrative embodiments makes the issuance and management of carbon credit tokens on the Ethereum compatible network more consistent, transparent, and compliant with securities regulations. It allows carbon credit token issuers and regulators to enforce compliance rules, such as investor accreditation and transfer restrictions, which can prevent illegal or harmful activities. It also enables the integration of off-chain data, such as legal documents or identity verification, into the token transactions, which can enhance the accountability and auditability of security token projects.

Solidity smart contract event logs and a third party tool such as a decentralized indexing system can provide traceability of each token.

Zero-Knowledge Succinct Non-Interactive Arguments of Knowledge (ZK-SNARK) can be used to provide confidential transactions in carbon credit trading. ZK-SNARK is a type of cryptographic proof that allows one party to demonstrate to another party that they possess certain information, without revealing the actual information itself.

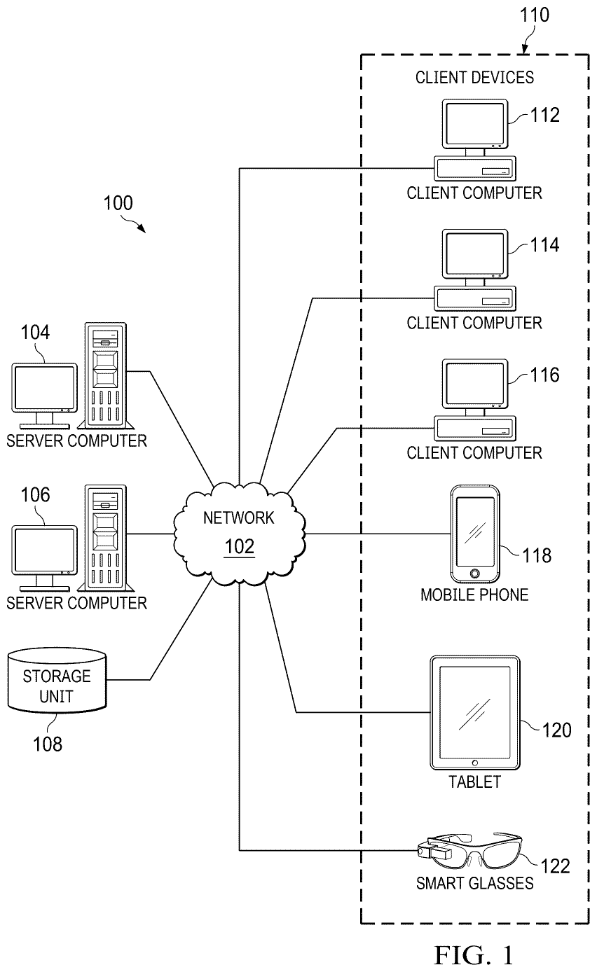

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 includes client computers 112, 114, and 116. Client devices 110 can also include other types of client devices such as mobile phone 118, tablet 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

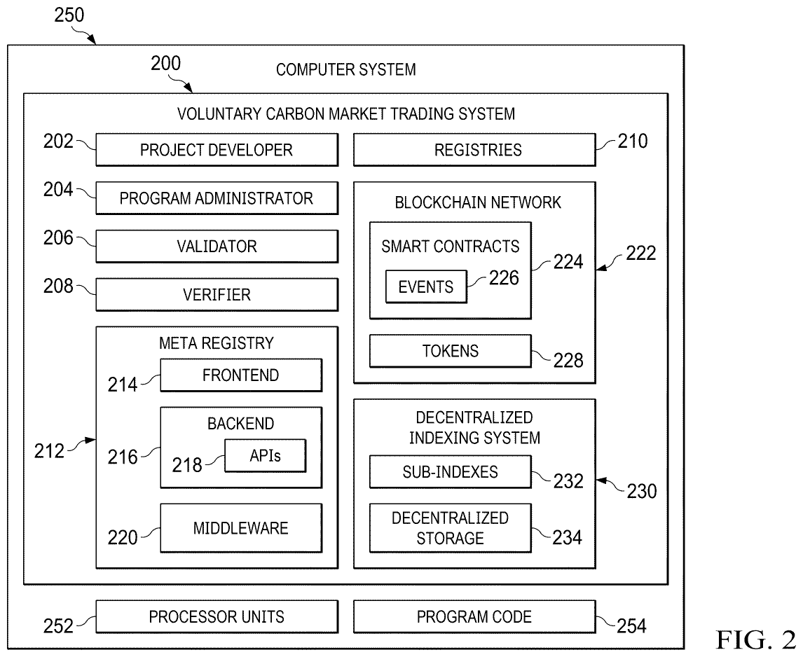

FIG. 2 is a block diagram of a voluntary carbon market trading system depicted in accordance with an illustrative embodiment. Voluntary carbon market trading system 200 might be implemented in network data processing system 100 in FIG. 1.

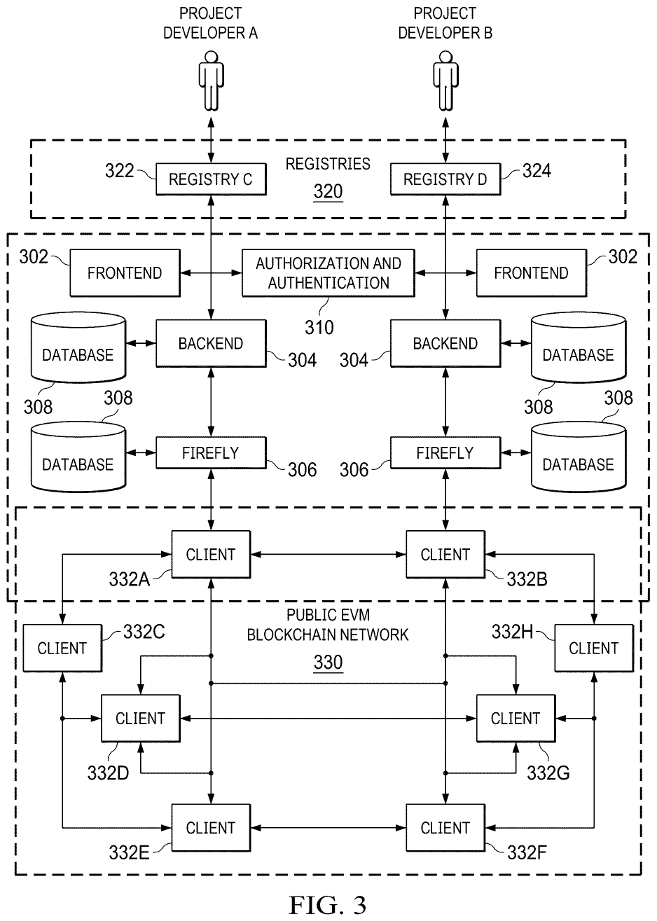

Voluntary carbon market trading system 200 comprises one or more registries 210 connected to a blockchain network 222 through meta registry 212. (See FIG. 3.)

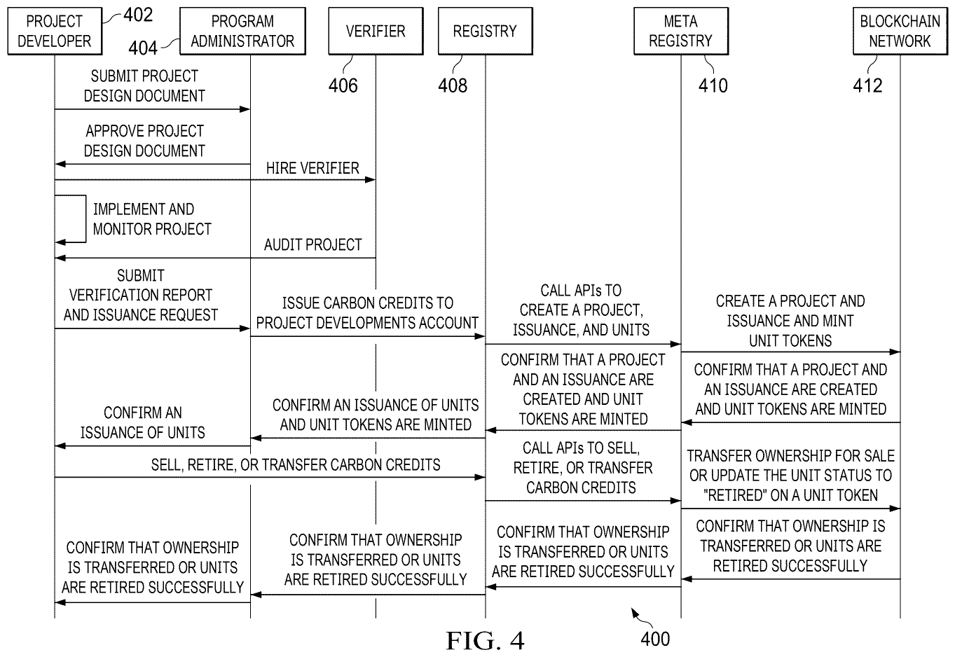

A number of parties may interact with voluntary carbon market trading system 200 including a project developer 202, program administrator 204, validator 206, and verifier 208 through respective interfaces. (See FIG. 4.) Project developer 202 develops projects that might require the creation, transfer, or redemption of carbon credits on a voluntary carbon market (VCM). Program administrator 204 is an entity that administers a standard or program that sets the rules and criteria for carbon credit issuance and verification. Validator 206 validates a project's eligibility and compliance with the relevant standard and methodology. Verifier 208 verifies a project's performance and greenhouse gas impacts over time through regular audits.

Meta registry 212 comprises frontend 214, backend 216, and middleware 220 such as, e.g., FireFly. Backend 216 comprises a number of application programming interfaces (APIs) that allow multiple registries 210 to communicate with blockchain network 222 to create, sell, transfer, and retire carbon credit tokens.

Blockchain network 222 comprises smart contracts 224 that execute the trading of tokens 228 corresponding to carbon credits on a VCM. Blockchain network 222 might be an EVM-compatible blockchain. Tokens 228 can be built on the ERC-1155, ERC-1594, and ERC-5484 token standards (explained below).

Events 226 related to smart contracts 224 can be recorded in decentralized indexing system 230. Sub-indexes 232 comprise APIs that extract event data from smart contracts 224 and store them in decentralized storage 234, thereby providing transparency for carbon credit transactions.

Voluntary carbon market trading system 200 can be implemented in software, hardware, firmware, or a combination thereof. When software is used, the operations performed by voluntary carbon market trading system 200 can be implemented in program code configured to run on hardware, such as a processor unit. When firmware is used, the operations performed by voluntary carbon market trading system 200 can be implemented in program code and data and stored in persistent memory to run on a processor unit. When hardware is employed, the hardware can include circuits that operate to perform the operations in voluntary carbon market trading system 200.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 250 is a physical hardware system and includes one or more data processing systems. When more than one data processing system is present in computer system 250, those data processing systems are in communication with each other using a communications medium. The communications medium can be a network. The data processing systems can be selected from at least one of a computer, a server computer, a tablet computer, or some other suitable data processing system.

As depicted, computer system 250 includes a number of processor units 252 that are capable of executing program code 254 for implementing processes in the illustrative examples. As used herein, a processor unit in the number of processor units 252 is a hardware device and is comprised of hardware circuits such as those on an integrated circuit that respond and process instructions and program code that operate a computer. When a number of processor units 252 execute program code 254 for a process, the number of processor units 252 is one or more processor units that can be on the same computer or on different computers. In other words, the process can be distributed between processor units on the same or different computers in a computer system. Further, the number of processor units 252 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

FIG. 3 depicts a diagram illustrating the implementation of a meta registry in accordance with an illustrative embodiment.

The meta registry illustrated in FIG. 3 provides connectivity to registries 320 in the voluntary carbon market. Meta registry 300 comprises frontend 302, backend 304, and a middleware open source software called Hyperledger FireFly 306 that connects between any EVM compatible client such as client 332a, client 332b, client 332c, client 332d, client 332e, client 332f, client 332g, client 332h, and backend 304.

Frontend 302 provides an interface for registries 320 and can be implemented with a JavaScript library such as React.js.

Backend 304 provides a server side JavaScript runtime environment and can be implemented with, e.g., Node.js. Backend 304 provides a set of APIs (application programming interfaces) that allow any of registries 320 to integrate with meta registry 300.

FireFly 306 is a multiparty middleware system designed to facilitate blockchain applications, particularly in enterprise environments. It provides a platform for building, deploying, and scaling decentralized applications that leverage blockchain networks without requiring deep expertise in blockchain infrastructure or cryptography.

For ease of illustration, the example in FIG. 3 shows two registries, registry c 322 and registry d 324, taking the form of RaaS (Registry as a Service) connecting to meta registry 300 and public EVM blockchain network 330. It should be kept in mind that meta registry 300 can connect to many more registries.

Each registry such as registry c 322 and registry d 324 connects to meta registry 300 through the same stack of technologies. Database 308, backend 304, and FireFly 306 can be hosted by respected partners such as standards and countries.

A user onboarding process on RaaS registries, registry c 322 and registry d 324 includes a KYC (Know Your Client) check by a registry administration staff. This process is the pre-requisite of a user account to be created in meta registry 300. Upon completion of the KYC check, a user record is sent to meta registry 300 via an API.

A user account is created in authorization and authentication 310 such as OKTA, database 308, and FireFly 306. An NFT (non-fungible token) based on the ERC-5484 standard is minted on public EVM blockchain network 330. ERC-5458 is an Ethereum standard that enables the creation of soulbound tokens (SBTs) that are non-transferable NFTs, meaning once they are assigned to a wallet address, they cannot be transferred or traded between users. A meta registry ID NFT is then available in the user's wallet. This NFT is a digital credential, which proves a valid KYC status and can be used by other purposes.

Only valid projects are created in meta registry 300. A registry will call a project API, and a project is created in database 308 and in a project smart contract. Upon a submission of the verification report to the standard, a project developer can send a request for issuance of carbon credits for a given vintage.

FIG. 4 depicts a process of issuing a given vintage and quantity of carbon credit units in the voluntary carbon market in accordance with an illustrative embodiment. Process 400 can be implemented in voluntary carbon market trading system 200 in FIG. 2 and meta registry 300 in FIG. 3.

An entity initiates and implements a project that aims to reduce or remove greenhouse gasses (GHGs) from the atmosphere. Project developer 402 submits a project design document to program administrator 404 that describes the project's objectives, activities, and expected outcomes.

Program administrator 404 reviews and approves the project design document and assigns a methodology to the project. Program administrator 404 is the entity that administers a standard or program that sets the rules and criteria for carbon credit issuance and verification. Examples of program administrators are Verra, Gold Standard, Global Carbon Council, and Woodland Carbon Code. A methodology is a set of procedures and formulas that determine how the project's GHG impacts are measured and verified.

A validator (not shown) validates the project's eligibility and compliance with the relevant standard and methodology. The validator is an independent third-party auditor that checks the project registration document and the project's baseline scenario. The baseline scenario is the expected GHG emissions in the absence of the project. The validator is only involved once at the beginning of the project.

Verifier 406 is the entity that verifies the project's performance and GHG impacts over time. Verifier 406 is also an independent third-party auditor that visits the project site and monitors the project's actual GHG emissions in a given year. Verifier 406 compares the actual GHG emissions with the baseline scenario and issues carbon credits accordingly. The verifier comes in once every year for the duration of the project.

Project developer 402 submits a verification report and issuance request to program administrator 404. Program administrator 404 issues carbon credits to the project developer's account in registry 408. Registry 408 makes API calls to meta registry 410 to create a project, issuance, and units. Meta registry 410 instructs blockchain network 412 to create a project and issuance and mint unit tokens. In this illustrative example, unit tokens are digital representations of ownership, access, or rights associated with assets. Unit tokens can include non-tangible tokens (NFTs) and tangible tokens.

Blockchain network 412 confirms to meta registry 410 that a project and an issuance are created and that the unit tokens are minted. Meta registry 410 confirms to registry 408 that a project and an issuance are created and that the unit tokens are minted. Registry 408 in turn confirms to program administrator 404 an issuance of units and that the unit tokens are minted. Program administrator 404 then confirms an issuance of units to project developer 402.

An intermediary facilitates the trade of carbon credits between project developers and buyers. Intermediaries can be traders, brokers, or retail aggregators. Traders buy and sell carbon credits to other traders or end users. Brokers act as middlemen between project developers and buyers. Retail aggregators buy large quantities of carbon credits and sell them to individual customers in smaller units. Intermediaries do not retire carbon credits, which means they do not cancel them from the market.

The end user is the entity that buys and retires carbon credits. End users can be corporations, governments, organizations, or individuals. End users buy carbon credits from project developers or intermediaries and retire them from the market. This means they cancel the carbon credits and claim the corresponding GHG reductions or removals. End users can use different registries to buy and retire carbon credits.

When carbon credits are traded, project developer 402 notifies registry 408 of the sale, retirement, or transfer of carbon credits. Registry 408 then makes API calls to meta registry 410 to sell, retire, or transfer carbon credits. Meta registry 410 instructs blockchain network 412 to transfer ownership for a sale or update the unit status to “retired” on a unit token.

Blockchain network 412 confirms to meta registry 410 that ownership has been transferred or that the units have been successfully retired. Meta registry 412 confirms to registry 408 that ownership has been transferred or that the units have been successfully retired. Registry 408 in turn confirms to program administrator 404 that ownership has been transferred or that the units have been successfully retired. Finally, program administrator 404 confirms to project developer 402 that ownership has been transferred or that the units have been successfully retired.

In order to provide the transparency and provenance of carbon credits, a provenance feature provides the traceability to show the state changes and transfers of ownerships of each carbon credit unit on the blockchain and to prove that the history of those changes is immutable.

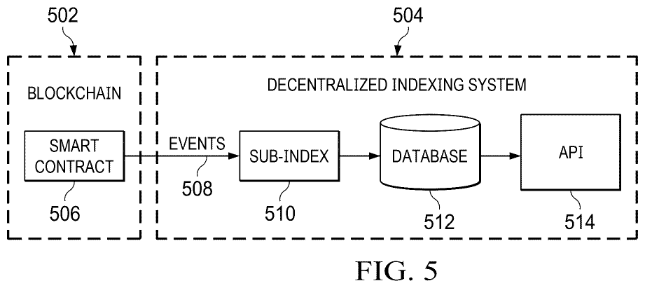

FIG. 5 depicts a diagram illustrating a provenance mechanism in accordance with an illustrative embodiment. Events 508 are a way of logging information that can be emitted by smart contracts 506. Events 508 can be used to record state changes and transfers of ownerships, as well as other relevant information, such as timestamps, parameters, and return values. Events 508 can be indexed and searched by external applications, e.g., through API 514, and can also be verified by using the transaction receipt and the block hash.

Decentralized indexing system 504 is a decentralized indexing system for indexing and querying data from blockchain 502, such as Ethereum. Decentralized indexing system 504 allows developers to create and publish open APIs, called sub-index 510, that make blockchain data easily accessible. Sub-index 510 defines how to extract and transform data from smart contract 508 and logs and stores them in database 512 that can be queried with GraphQL via API 514.

Using decentralized indexing system 504 to present events and logs can help developers and auditors to monitor and verify the state changes and transfers of ownerships in solidity smart contracts. For example, sub-index 510 can track the creation, transfer, and sale of the NFTs, as well as the metadata and characteristics of each NFT. A sub-index for Uniswap can track the liquidity, volume, and price of each token pair, as well as the transactions and fees of each swap.

Using decentralized indexing system 504 to present events and logs can also enable new possibilities for data analysis and visualization. For example, a tool called Explorer can help users to explore and interact with sub-indexes, and visualize the data in various ways, such as tables, charts, maps, and networks.

Decentralized indexing system 504 is a powerful and flexible tool for providing traceability of state changes and transfers of ownerships in solidity smart contracts. Decentralized indexing system 504 can help developers and auditors to index and query blockchain data, as well as to present and analyse the data in various ways.

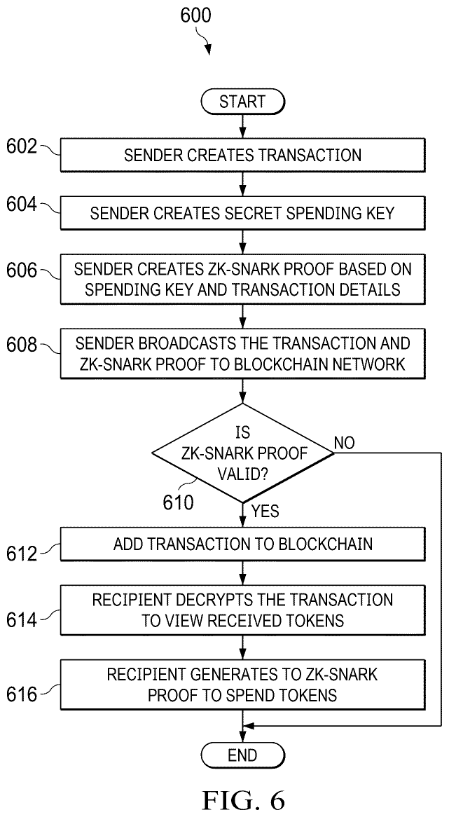

FIG. 6 depicts a flowchart illustrating Carbon Credit Unit token transfer in a ZK-SNARK blockchain network in accordance with an illustrative embodiment. Process 600 can be implemented with meta registry 300 and is an example of events 508 in FIG. 5. It is vital to protect the privacy of the traders and brokers, who may not want to disclose their trading strategies or their competitive advantages to the public or their competitors.

The ZK-SNARK (Zero-Knowledge Succinct Non-Interactive Arguments of Knowledge) technique is used to provide confidential transactions in Carbon Credit trading. ZK-SNARK provides a way to prove the correctness of a computation without revealing the inputs or intermediate steps. Complex computations are transformed into succinct proofs that can be verified without re-executing the computation.

Process 600 begins with the sender creating a transaction that specifies a number of tokens to be transferred, the recipient's address, and a random nonce (step 602). The sender also generates a secret spending key that only the sender knows (step 604).

The sender uses the spending key and the transaction details to create a ZK-SNARK proof (step 606). This proof demonstrates that the sender has the right to spend the tokens, that the transaction is valid, and that the balance is preserved. However, the proof does not reveal any information about the sender, the recipient, or the number of tokens.

The sender broadcasts the transaction and the ZK-SNARK proof to the blockchain network (step 608). The network validators verify the ZK-SNARK proof using a public verification key and a set of parameters that are generated during the network initialization (step 610). If the proof is valid, the transaction is accepted and added to the blockchain (step 612).

The recipient can scan the blockchain and use their own secret viewing key to decrypt the transaction and see the number of tokens they received (step 614). The recipient can also generate a new ZK-SNARK proof to spend the tokens they received (step 616).

The privacy of the token transfer is ensured by the zero-knowledge property of the ZK-SNARK proof. The proof only reveals that the transaction is correct, but not the details of the transaction. Therefore, no one can link the sender and the recipient, or trace the history of the tokens. The only information that is publicly visible on the blockchain is the hash of the transaction and the proof.

A meta registry that utilizes an EVM-compatible blockchain can create transactions on a public blockchain(s) that are transparent, traceable, and immutable. By using the blockchain to connect different registries of carbon credits (e.g., Verra, Gold Standard) the risk of double counting is reduced in a number of ways. The meta registry enables unique identification such as reference ID, serial number, and tracking of each carbon credit issuance, thereby preventing the same credit from being issued, claimed, or used more than once.

The meta registry facilitates peer-to-peer exchange of carbon credits and provides connectivity to intermediaries, thereby reducing the transaction costs and delays and increasing the efficiency and liquidity of the market. The meta registry can provide a verifiable and tamper-proof record of the carbon credit lifecycle, from issuance to retirement, ensuring the integrity and credibility of the carbon credits. Therefore, the meta registry is a solution to the trust and transparency issues in the voluntary carbon market and helps scale up the demand and supply of carbon credits.

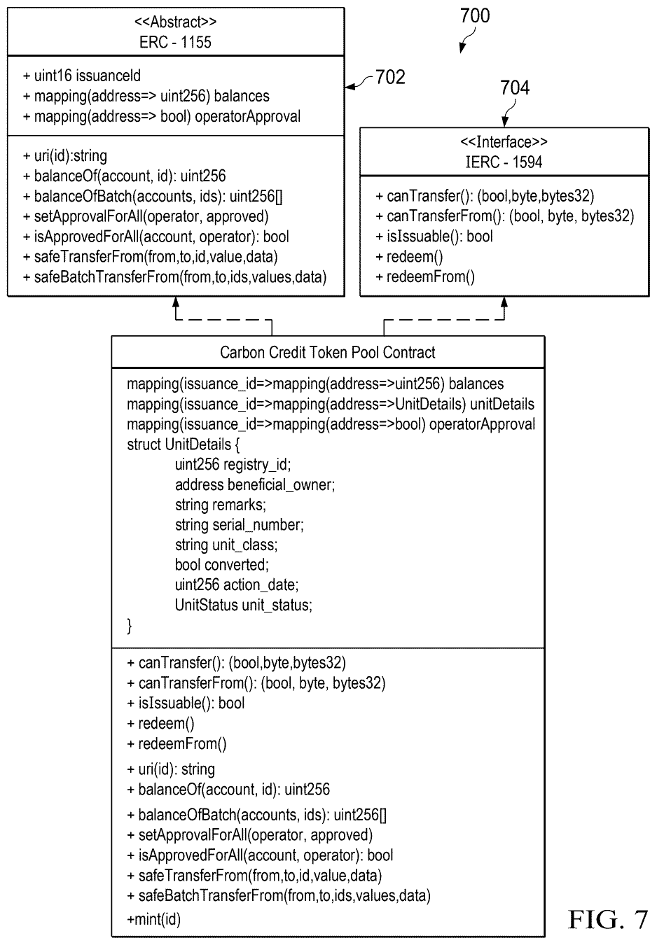

FIG. 7 depicts a carbon credit token in accordance with an illustrative embodiment. Carbon credit token 700 can be minted and utilized by public EVM blockchain network 330 in FIG. 3. As mentioned above, carbon credit token 700 comprises several Ethereum token standards including ERC-1155, IERC-1594, and ERC-5484.

ERC- 1155 702 is a multi-token standard on the Ethereum blockchain that allows for the creation of both fungible and non-fungible tokens within the same contract. ERC-1155 702 allows for batch transfers in which multiple tokens can be sent in a single transaction, making the standard more scalable and cost-efficient for high-volume token operations. The meta registry may involve many carbon credit unit transactions. ERC-1155 702 can handle these transactions more efficiently than ERC-721 because ERC-1155 702 allows for batch transfers of multiple tokens in one operation, whereas ERC-721 requires a separate transaction for each token. This can save on “gas fees,” which are the transaction costs on the Ethereum blockchain.

IERC-1594 704 is an Ethereum token standard designed for security tokens, which are tokenized versions of traditional securities like stocks, bonds, and derivatives. Security tokens must meet regulatory and compliance requirements. IERC-1594 704 can provide functions related to regulators'requirements. As such, IERC-1594 704 supports the implementation of transfer restrictions, allowing token issuers to control who can buy or sell the security token in compliance with regulations and includes functions to check whether a transfer can be completed before executing it, helping to ensure only compliant transfers.

‘canTransfer( )’ and ‘canTransferFrom( )’ are functions that check the validity and reason of failure for any transfer of carbon credit unit tokens, which can depend on various factors such as the KYC status, accreditation of the sender or receiver, or the state of the token itself. These functions return a Boolean value indicating whether the transfer is allowed or not.

‘isIssuable( )’ is a function that returns a Boolean value indicating whether the carbon credit unit token is still in the issuance phase or not. This function can be used to enforce certain conditions or restrictions on issuing new unit tokens, such as a vintage or the total supply per issuance.

‘redeem( )’ and ‘redeemFrom( )’ are functions that allow a token holder or an approved operator to redeem tokens. The redeemed tokens must be subtracted from the total supply and the balance of the token holder. Token redemption acts like sending tokens and is subject to the same conditions. These functions also emit a Redeemed event that records the operator, the token holder, the value, and the data of the redemption.

‘setApprovalForAll( )’ is a function that allows an administrator to authorize or revoke an operator to manage all of their unit tokens. This function can be useful for delegating the transfer or redemption of tokens to a third party, such as a broker or an exchange.

‘isApprovedForAll( )’ is a function that returns a Boolean value indicating whether an operator is authorized to manage all of the tokens of a given account. This function can be used to verify the permission of an operator before executing a transfer or redemption on behalf of a token holder.

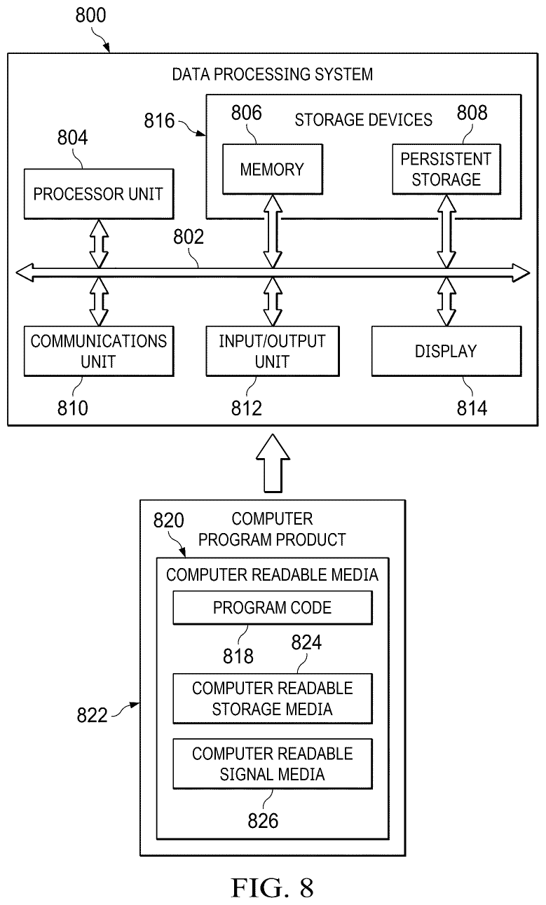

Turning now to FIG. 8, an illustration of a block diagram of a data processing system is depicted in accordance with an illustrative embodiment. Data processing system 800 may be used to implement server computer 104 and server computer 106 and client devices 110 in FIG. 1, as well as computer system 250 in FIG. 2. In this illustrative example, data processing system 800 includes communications framework 802, which provides communications between processor unit 804, memory 806, persistent storage 808, communications unit 810, input/output unit 812, and display 814. In this example, communications framework 802 may take the form of a bus system.

Processor unit 804 serves to execute instructions for software that may be loaded into memory 806. Processor unit 804 may be a number of processors, a multi-processor core, or some other type of processor, depending on the particular implementation. In an embodiment, processor unit 804 comprises one or more conventional general-purpose central processing units (CPUs). In an alternate embodiment, processor unit 804 comprises one or more graphical processing units (GPUs).

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, may be, for example, a random access memory or any other suitable volatile or non-volatile storage device. Persistent storage 808 may take various forms, depending on the particular implementation.

For example, persistent storage 808 may contain one or more components or devices. For example, persistent storage 808 may be a hard drive, a flash memory, a rewritable optical disk, a rewritable magnetic tape, or some combination of the above. The media used by persistent storage 808 also may be removable. For example, a removable hard drive may be used for persistent storage 808. Communications unit 810, in these illustrative examples, provides for communications with other data processing systems or devices. In these illustrative examples, communications unit 810 is a network interface card.

Input/output unit 812 allows for input and output of data with other devices that may be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs may be located in storage devices 816, which are in communication with processor unit 804 through communications framework 802. The processes of the different embodiments may be performed by processor unit 804 using computer-implemented instructions, which may be located in a memory, such as memory 806.

These instructions are referred to as program code, computer-usable program code, or computer-readable program code that may be read and executed by a processor in processor unit 804. The program code in the different embodiments may be embodied on different physical or computer-readable storage media, such as memory 806 or persistent storage 808.

Program code 818 is located in a functional form on computer readable media 820 that is selectively removable and may be loaded onto or transferred to data processing system 800 for execution by processor unit 804. Program code 818 and computer readable media 820 form computer program product 822 in these illustrative examples. In one example, computer readable media 820 may be computer readable storage media 824 or computer readable signal media 826.

In these illustrative examples, computer readable storage media 824 is a physical or tangible storage device used to store program code 818 rather than a medium that propagates or transmits program code 818. Computer readable storage media 824, as used herein, is not to be construed as being transitory signals per se, such as radio waves or other freely propagating electromagnetic waves, electromagnetic waves propagating through a waveguide or other transmission media (e. g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 818 may be transferred to data processing system 800 using computer readable signal media 826. Computer readable signal media 826 may be, for example, a propagated data signal containing program code 818. For example, computer readable signal media 826 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 800 are not meant to provide architectural limitations to the manner in which different embodiments may be implemented. The different illustrative embodiments may be implemented in a data processing system including components in addition to or in place of those illustrated for data processing system 800. Other components shown in FIG. 8 can be varied from the illustrative examples shown. The different embodiments may be implemented using any hardware device or system capable of running program code 818.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C, or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component with an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A meta registry for blockchain transactions, the meta registry being a system configured to operate as an integration layer between a plurality of independently operated registries and a blockchain network, the meta registry comprising:
a frontend interface configured to communicate with the plurality of independently operated registries and provide a unified access point to carbon credit transaction data aggregated from the plurality of independently operated registries;
a server side backend that provides a set of application programming interfaces (APIs) configured to integrate each of the plurality of independently operated registries with the meta registry by enabling each of the plurality of independently operated registries to transmit carbon credit transaction data to the meta registry and receive transaction confirmations from the meta registry, wherein the APIs allow any of the plurality of independently operated registries to communicate with the blockchain network to create, sell, transfer, and retire carbon credit tokens; and
a middleware system that connects the server side backend to a number of clients in the blockchain network, wherein the middleware system is configured to implement a communication protocol compatible with the blockchain network to transmit carbon credit transaction data aggregated from the plurality of independently operated registries to the number of clients in the blockchain network.

2. The meta registry of claim 1, wherein the server side backend instructs the blockchain network to issue and mint tokens in response to API calls from the plurality of independently operated registries.

3. The meta registry of claim 2, wherein the server side backend confirms, to the plurality of independently operated registries, the issuance and the minting of tokens by the blockchain network.

4. The meta registry of claim 2, wherein the tokens represent carbon credits for a voluntary carbon market.

5. The meta registry of claim 2, wherein the tokens are non-transferable, non-fungible tokens.

6. The meta registry of claim 5, wherein the tokens are based on Ethereum Request for Comment (ERC)-1155, ERC-1594, and ERC-5484 token standards.

7. The meta registry of claim 1, wherein the server side backend instructs the blockchain network to sell, transfer, or retire tokens in response to API calls from the plurality of independently operated registries.

8. The meta registry of claim 7, wherein the server side backend confirms, to the plurality of independently operated registries, the sale, the transfer, or the retirement of the tokens by the blockchain network.

9. The meta registry of claim 7, wherein the sale, the transfer, or the retirement of the tokens is logged in a decentralized indexing system according to information generated by smart contracts in the blockchain network.

10. The meta registry of claim 9, wherein open APIs define how to extract and transform data from smart contract events and logs and store them in a decentralized storage.

11. The meta registry of claim 7, wherein the sale or the transfer of tokens by the blockchain network further comprises a Zero-Knowledge Succinct Non-Interactive Arguments of Knowledge proof transmitted to the blockchain network in connection with the sale or the transfer.

12. The meta registry of claim 1, wherein the blockchain network comprises an Ethereum Virtual Machine (EVM) blockchain network.

13. A blockchain transaction system, comprising:
plurality of independently operated registries;
a blockchain network; and
a meta registry configured to operate as an integration layer between the plurality of independently operated registries and the blockchain network, the meta registry comprising:
a frontend interface configured to communicate with the plurality of independently operated registries and provide a unified access point to transaction data aggregated from the plurality of independently operated registries;
a server side backend that provides a set of application programming interfaces (APIs) configured to integrate each of the plurality of independently operated registries with the meta registry by enabling each of the plurality of independently operated registries to transmit transaction data to the meta registry and receive transaction confirmations from the meta registry, wherein the APIs allow any of the plurality of independently operated registries to communicate with the blockchain network to create, sell, transfer, and retire carbon credit tokens; and
a middleware system that connects the server side backend to a number of clients in the blockchain network, wherein the middleware system is configured to implement a communication protocol compatible with the blockchain network to transmit transaction data aggregated from the plurality of independently operated registries to the number of clients in the blockchain network, wherein the server side backend instructs the blockchain network to issue and mint tokens in response to API calls from the plurality of independently operated registries, and wherein the server side backend instructs the blockchain network to sell, transfer, or retire tokens in response to API calls from the plurality of independently operated registries.

14. The blockchain transaction system of claim 13, wherein the tokens represent carbon credits for a voluntary carbon market.

15. The blockchain transaction system of claim 13, wherein the tokens are non-transferable, non-fungible tokens.

16. The blockchain transaction system of claim 13, wherein the tokens are based on Ethereum Request for Comment (ERC)-1155, ERC-1594, and ERC-5484 token standards.

17. The blockchain transaction system of claim 13, wherein the sale, the transfer, or the retirement of the tokens is logged in a decentralized indexing system according to information generated by smart contracts in the blockchain network.

18. The blockchain transaction system of claim 13, wherein the sale or the transfer of tokens by the blockchain network further comprises a Zero-Knowledge Succinct Non-Interactive Arguments of Knowledge proof transmitted to the blockchain network in connection with the sale or the transfer.

19. The blockchain transaction system of claim 13, wherein the server side backend confirms, to the plurality of independently operated registries, the issuance, the minting, the sale, the transfer, or the retirement of tokens by the blockchain network.

20. A carbon credit blockchain transaction system, comprising:
a plurality of independently operated registries for a voluntary carbon market;
a blockchain network configured to record carbon credit transactions on a distributed ledger; and
a meta registry configured to operate as an integration layer between the plurality of independently operated registries and the blockchain network, the meta registry comprising:
a server side backend that provides a set of application programming interfaces (APIs) configured to integrate each of the plurality of independently operated registries with the meta registry by enabling each of the plurality of independently operated registries to transmit carbon credit transaction data to the meta registry and receive transaction confirmations from the meta registry; and
a middleware system that connects the server side backend to a number of clients in the blockchain network, wherein the middleware system is configured to implement a communication protocol compatible with the blockchain network to transmit carbon credit transaction data aggregated from the plurality of independently operated registries to the number of clients in the blockchain network, wherein the server side backend instructs the blockchain network to execute smart contracts for tokens corresponding to carbon credits on the voluntary carbon market in response to API calls from the plurality of independently operated registries, wherein the tokens are based on Ethereum Request for Comment (ERC)-1155, ERC-1594, and ERC-5484 token standards, and wherein events related to the smart contracts are logged in a decentralized indexing system.
